(19) United States
(12) Patent Application Publication
(10) Pub. No.: US 2012/0223834 A1
(43) Pub. Date: Sep. 6, 2012

(54) TRACKING AND MONITORING SYSTEM

(76) Inventor: DeQuincy A. Hyatt, Madison Heights, MI (US)

(21) Appl. No.: 13/410,263

(22) Filed: Mar. 1, 2012

Related U.S. Application Data
(60) Provisional application No. 61/448,104, filed on Mar. 1, 2011.
(60) Provisional application No. 61/475,740, filed on Apr. 15, 2011.

(51) Int. Cl. G08B 1/08

(52) U.S. Cl. 340/539.13

(57) ABSTRACT

A tracking and monitoring system for monitoring children in a park includes a child tracking device that is associated with each of the children. A guardian tracking device is assigned to a guardian of the child and associated with the child tracking device. The locations of the devices are monitored. Alerts can be generated based upon a distance between the child and guardian tracking devices exceed a threshold.

This application claims priority to U.S. Provisional Application Ser. Nos. 61/448,104 filed Mar. 1, 2011 and 61/475,740 filed Apr. 15, 2011.

### BACKGROUND

The present invention relates generally to tracking devices.

Due to the large areas and large crowds, many visitors to amusement parks or theme parks have at one time or another lost their child. Even a brief separation can cause great anxiety for the parents. The size of the park and the large crowds even make it difficult for park employees to find a lost child quickly.

### SUMMARY

A tracking and monitoring system for monitoring children in a park includes a child tracking device that is associated with each of the children. A guardian tracking device is assigned to a guardian of the child and associated with the child tracking device. The locations of the devices are monitored. Alerts can be generated based upon a distance between the child and guardian tracking devices exceed a threshold.

These and other features of the application can be best understood from the following specification and drawings, the following of which is a brief description.

### BRIEF DESCRIPTION OF THE DRAWINGS

FIG. 1A is a perspective view of a tracking device according a first embodiment of the present invention.

FIG. 1B is an enlarged view of the two ends of the watchband of FIG. 1A.

FIG. 2A is an enlarged view of two ends of an alternate watchband.

FIG. 2B illustrates the watchband of FIG. 2A in a locked position.

FIG. 3 illustrates an alternate tracking device.

FIG. 4 illustrates a third alternate tracking device.

FIG. 5 is a schematic of a tracking and monitoring system including one of the tracking devices of FIGS. 1-4.

FIG. 6 illustrates a tracking device according to a fourth alternate embodiment.

FIG. 7 illustrates a tracking device according to a fifth alternate embodiment.

FIG. 8 illustrates a tracking device according to a sixth alternate embodiment.

FIG. 9 illustrates an alternate lock that can be used in the tracking device of FIG. 8.

FIG. 10 illustrates a second alternate lock that can be used in the tracking device of FIG. 8.

FIG. 11 illustrates a third alternate lock that can be used in the tracking device of FIG. 8.

FIG. 12 schematically illustrates a locking mechanism that can be used in the locks of FIGS. 8-11.

FIG. 13 illustrates a tracking device according to a seventh alternate embodiment.

FIG. 14 illustrates a tracking device according to an eighth alternate embodiment.

FIG. 15 is a perspective view of a tracking device according to a ninth alternate embodiment and a key for use with the tracking device.

FIG. 16 is an enlarged view of a portion of the tracking device of FIG. 15, showing the lock.

FIG. 17 is a schematic view of the tracking device of FIG. 15, showing some of the interior components.

FIG. 18 is a bottom perspective view of the tracking device of FIG. 15.

FIG. 19 is a schematic of a tracking and monitoring system for use in a park.

### DETAILED DESCRIPTION OF THE PREFERRED EMBODIMENT

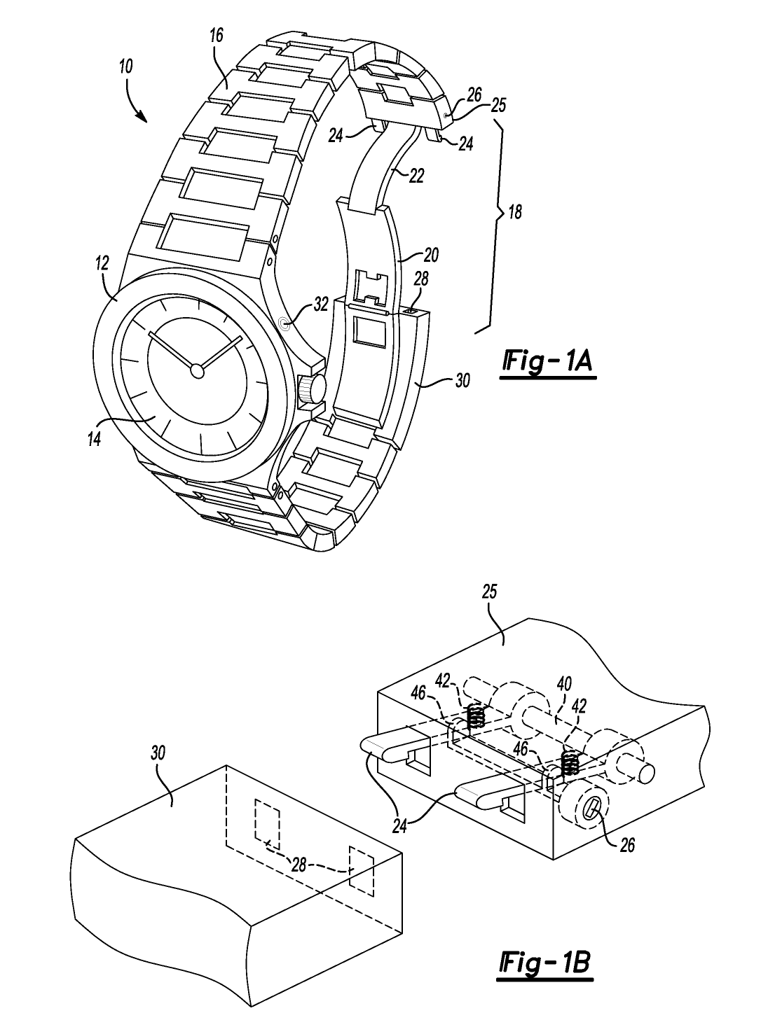

FIG. 1A is a perspective view of a tracking device 10 according to a first embodiment of the present invention. The tracking device 10 includes a watch body 12 having a watch display, such as watch face 14 (watch display could also be a digital display). A watchband 16 is connected to the watch body 12 and is selectively closable by a fastening system 18. The fastening system 18 includes a first curved bar 20 and second curved bar 22 pivotably connected and connecting a first connecting link 25 and a second connecting link 30. A first connecting link 25 includes a pair of hooks 24 extending therefrom. The hooks 24 are selectively lockable by keyway 26. The hooks 24 are also receivable within apertures 28 on the second connecting link 30.

The watch body 12 is fully functional as a watch, including watch hands on a watch face 14. Alternatively, digital watches could also be provided in any of the embodiments shown in this application. The watch body 12 further includes an optional “panic” or “help” button 32 that is recessed into the body 12.

Referring to FIG. 1B, inside the first connecting link 25, the hooks 24 are pivotable on (or pivotable with) a shaft 40 and are biased toward a locked position by springs 42. The hooks 24 are biased downwardly by the springs 42 and can be selectively released by cams 46 rotatable by the keyway 26. The second connector link 30 includes apertures 28 into which the hooks 24 can be received and to which the hooks 24 are latched. When the hooks 24 are inserted into the apertures 28 and the keyway 26 is rotated to the lock position, the springs 42 bias the hooks 24 downwardly, thereby locking the hooks 24 in the apertures 28 and locking the first connector link 25 to the second connector link 30. In this position, the tracking device 10 cannot be removed from the user's wrist. The keyway 26 can be rotated such that the cams 46 push the hooks 24 upwardly, thereby releasing the hooks 24 from the apertures 28 so that they can be removed from the apertures 28 and the first connecting link 25 can be separated from the second connecting link 30 and the tracking device 10 can be removed.

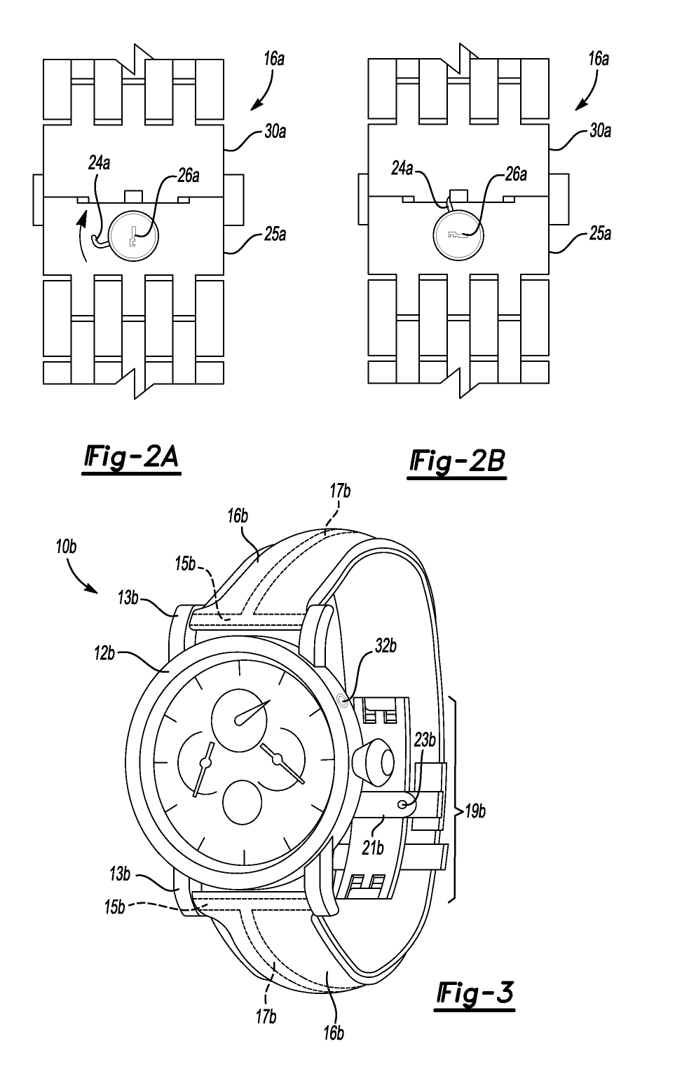

FIGS. 2A and 2B show an alternate connection mechanism. A first connector link 25a is connected to a second connector link 30a by a rotating keyway 26a. A hook 24a rotates inside the first connector link 25a upward rotation of the keyway 26a. The hooks 24a is received within an aperture (not visible) in the second connector link 30a, thereby rendering the watchband 16a irremovable from the user. The watchband 16a can then be removed by unlocking the second connector link 30a from the first connector link 25a by rotation of the keyway 26a.

FIG. 3 illustrates a third embodiment of a tracking device 10b. A watch body 12b includes two pair of spaced apart prongs 13b connected by a crossbar 15b. A flexible braided cable 17b is connected to each crossbar 15b. The cable 17b and crossbar 15b are hidden inside another (or other material) watchband 16b. The connection between the two watchband halves may be as indicated in FIG. 1A and FIG. 1B. An adjustment mechanism 19b is also provided. The adjustment mechanism 19b is similar to known watchband mechanisms in which a lever clamps down onto the watchband halves. However, in the tracking device 10b, the lever 21b is retained by a fastener, such as an Allen screw 23b. Thus, adjustment of the watchband 16b can be provided, but the watchband 16b cannot be adjusted while the user is wearing the tracking device 10b. Again the tracking device 10b is connected and disconnected similar to the connection system 18 of FIGS. 1A and 1B.

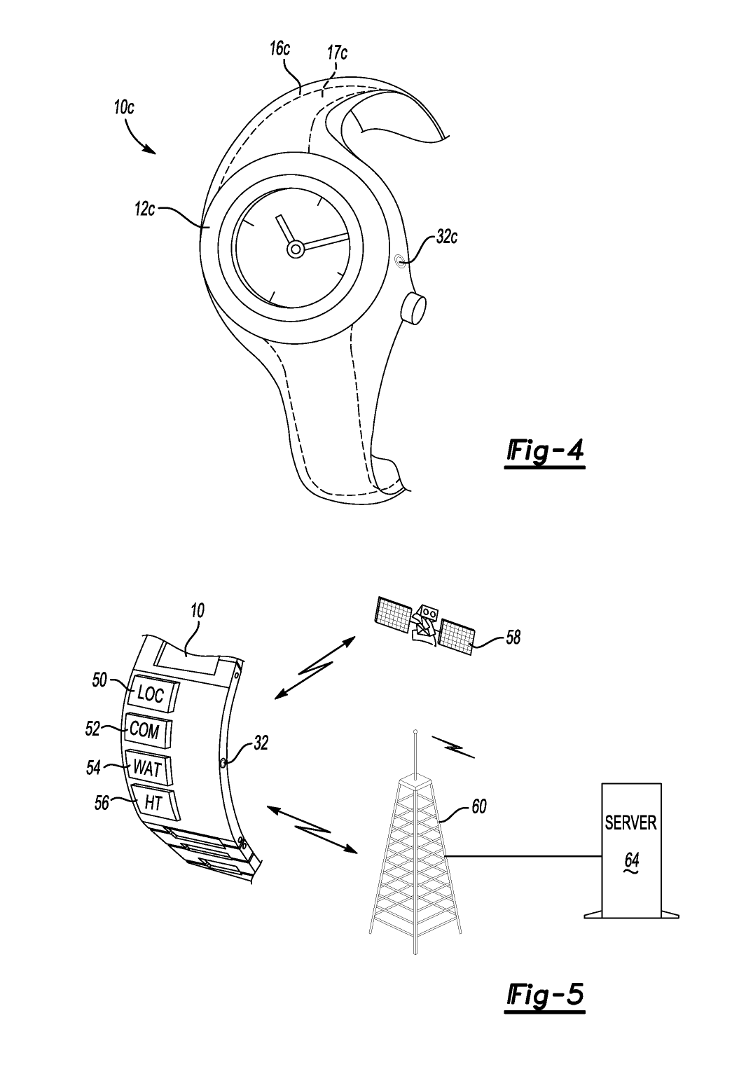

FIG. 4 illustrates another embodiment of the tracking device 10c. In this embodiment, a flexible metal band or braided cable 17c is connected directly to the watch body 12c, such as by welding, soldering, or other permanent connection. The cable 17c is hidden within the leather (or other material) band 16c such that the tracking device 10c appears to be an ordinary watch. The watchband 16c is connected and disconnected according to any of the connection systems of FIGS. 1-3.

FIG. 5 is a schematic illustrating a tracking and monitoring system in which the tracking device 10 can be used. The tracking device 10 can be any of the tracking devices 10, 10a, 10b, 10c of FIGS. 1-4 or any suitable variation. The tracking device 10 includes locating circuitry 50 (such as GPS receiver or cell phone circuitry whose location is determined by cell towers 60). The tracking device 10 may further include communication circuitry 52, such as cell phone or other wireless data transmission circuitry. The tracking device 10 further includes a watch function 54, such that the tracking device 10 operates and appears as a normal watch. The tracking device 10 may optionally include a health monitoring circuit 56, such as for monitoring heart rate, blood pressure, temperature, blood sugar and stress. This health related information can be used to either trigger a communication or can be periodically transmitted from the tracking device via communication circuitry 52, or can be retrieved via the communication circuitry 52. The health monitoring circuit 56 also ensures that the tracking device 10 is secured to the user, in that the health monitoring circuit 56 sends a signal to the server 64 when health signals cannot be measured (i.e. no heartbeat, no blood pressure, no temperature, etc), thereby indicating that the user may have removed the tracking device.

The tracking device 10 further includes a panic or help button 32, with which the user can request assistance by initiating communication via the communication circuitry 52, which automatically transmits the location of the tracking device 10 as determined by the locating circuitry 50 (if the location of the tracking device 10 has not already been determined directly by the cell towers 60), and optionally health related information to a cell tower 60 or other external communication circuitry (including wi-fi, or other data communication protocalls). The cell tower 60 is in communication with a central server 64. The central server 64 is equipped to monitor thousands of such tracking devices over a large area. The identification of the individual wearing the tracking device is stored in the server 63 and associated with that particular tracking device. Health information, contact information, historical information are all stored on server 64 and associated with that individual's tracking device 10. Satellites 58 also communicate with tracking device 10, including the locating circuitry 50 and optionally the communication circuitry 52.

In use, if an individual is reported missing by their family, the server 64 can track the location of the individual's tracking device 10 and report that location to the family or to the authorities. The operators monitoring the server 64 can also track the health status of the individual wearing the tracking device 10 and report this to the family members or other authorities.

In some situations, if the individual wearing the tracking device 10 becomes lost or otherwise is in need of assistance, they either can press the help or panic button 32 which will initiate a call for help to the central server 64.

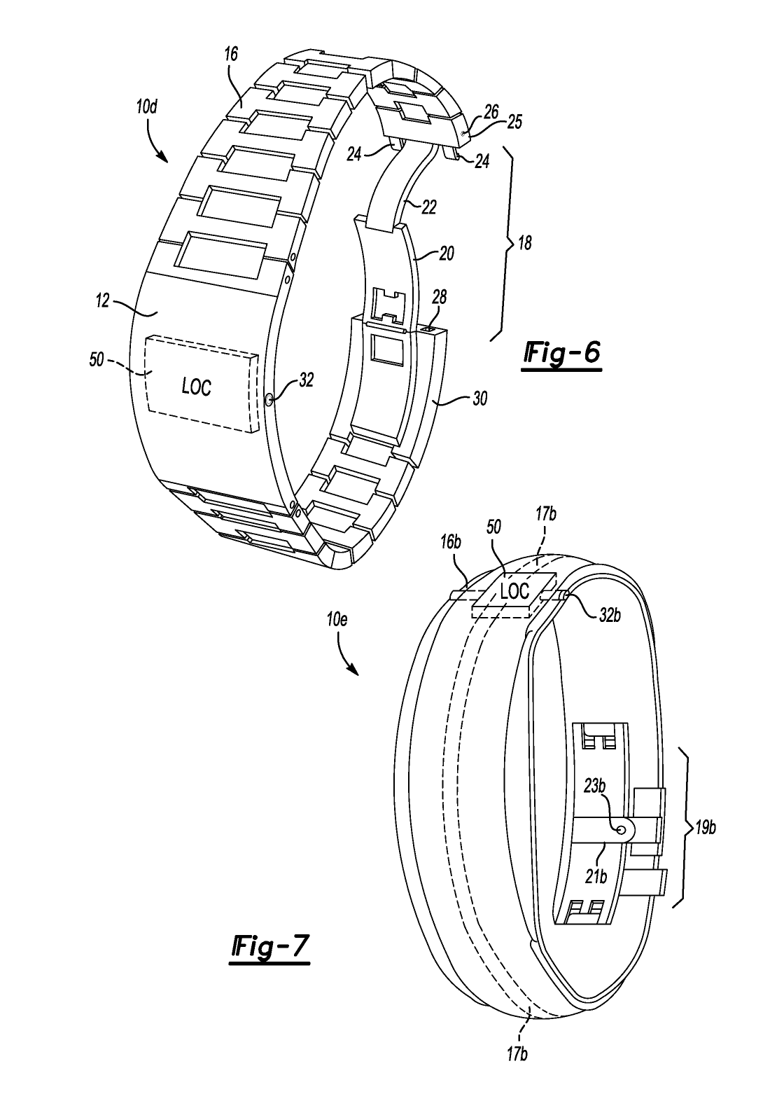

FIG. 6 illustrates a tracking device 10d according to a fourth alternate embodiment. In the tracking device 10d, a locating circuitry 50 is hidden inside a body 12 of the tracking device 10d (or alternatively, inside the band 16). The tracking device 10d is substantially similar to the tracking device 10a of FIGS. 1A and 1B, except that there is no watch face or display and the tracking device 10d is just a bracelet. Other variations are possible, but the band 16 and fastening system 18 may be as shown in the embodiment of FIGS. 1A and 1B.

FIG. 7 illustrates a tracking device 10e according to a fifth alternate embodiment. Locating circuitry 50 is hidden inside of the tracking device 10e (in this embodiment, inside the band 16). The tracking device 10e is substantially similar to the tracking device 10a of FIG. 3, except that there is no watch 12b and the tracking device 10d is just a bracelet. Other variations are possible, but the band 16b and fastening system 19b may be as shown in the embodiment of FIG. 3.

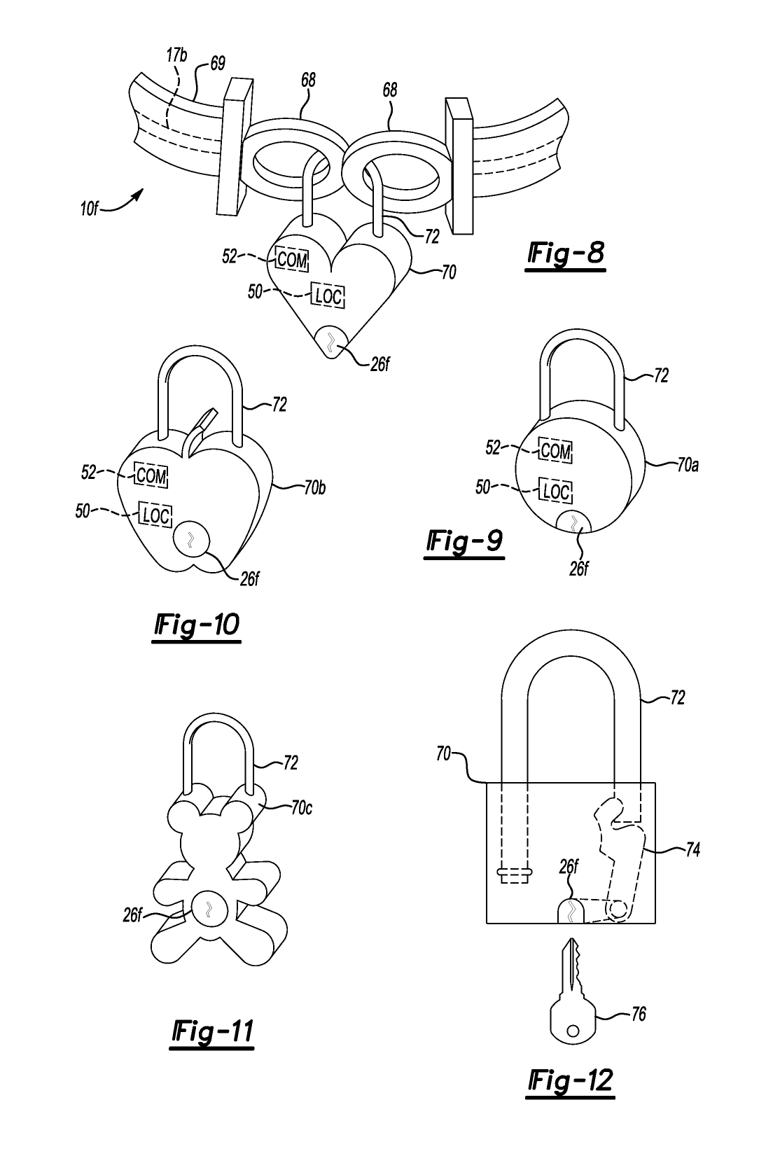

FIG. 8 illustrates a tracking device 10f according to a sixth alternate embodiment. Locating circuitry 50 is hidden inside of the tracking device 10f, in this embodiment, inside a lock 70. The lock 70 may also conceal a communication circuit 52. The lock 70 includes a U-shaped portion 72 that is retractable and pivotable relative to the body of the lock 70, similar to known padlocks. The lock 70 is selectively operated by a key-way 26f, again, in a manner similar to known padlocks. In this embodiment, the lock 70 connects to eyelets 68 that are welded or otherwise permanently secured to a cable 17b, which is hidden in a band 69, in a manner similar to FIG. 3. The band 69 could be leather or other material, which is fashionable and hides the cable 17b, which prevents the band 69 from being cut.

FIGS. 9-11 show alternate locks 70a, 70b and 70c. All of the locks 70, 70a-70c have a decorative shape, which hides the fact that it is a lock and that it contains a tracking device. Other shapes could be utilized as well.

FIG. 12 schematically illustrates one of the locks, such as lock 70. Generally, a latch 74 selectively is latched to the U-shaped portion 72 by operation of the key-way 26f with a key 76. Many such locks are known in existing padlocks and any design could be used.

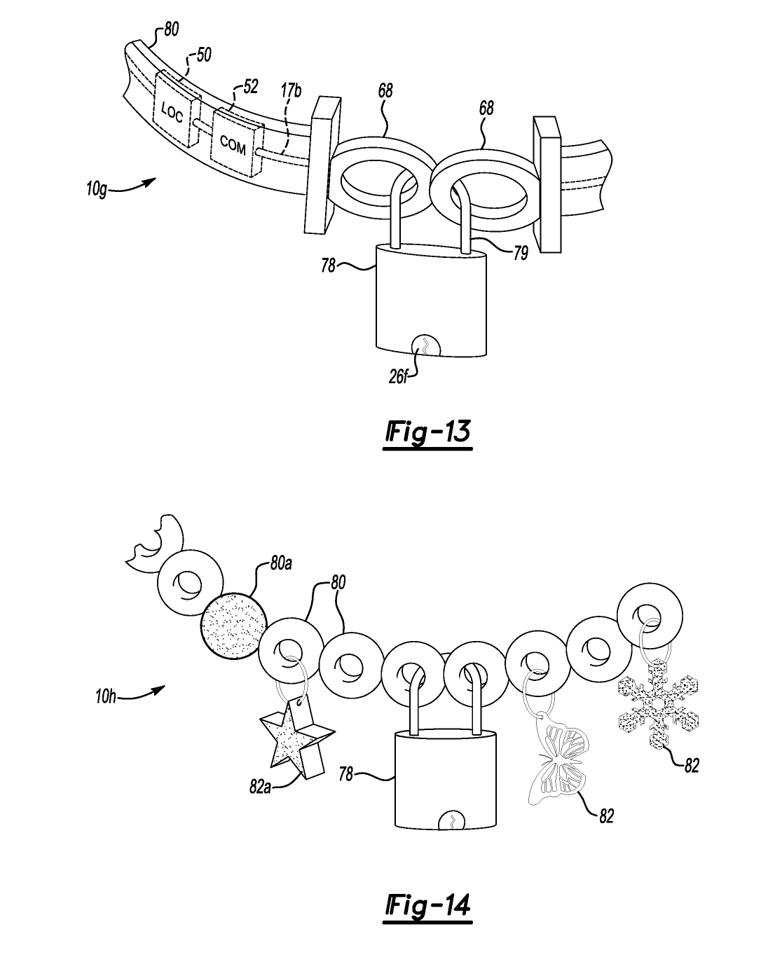

FIG. 13 illustrates a seventh alternate embodiment of a tracking device 10g. In this example, the lock 78 is simply a lock with a retractable U-shaped portion 79 and a key-way 26f. The lock 78 selectively secures the two eyelets 68, which are secured to the cable 17b hidden within a band 80, as before. However, in this tracking device 10g, the locating circuitry 50 is hidden inside the band 80, as is the communication circuit 52.

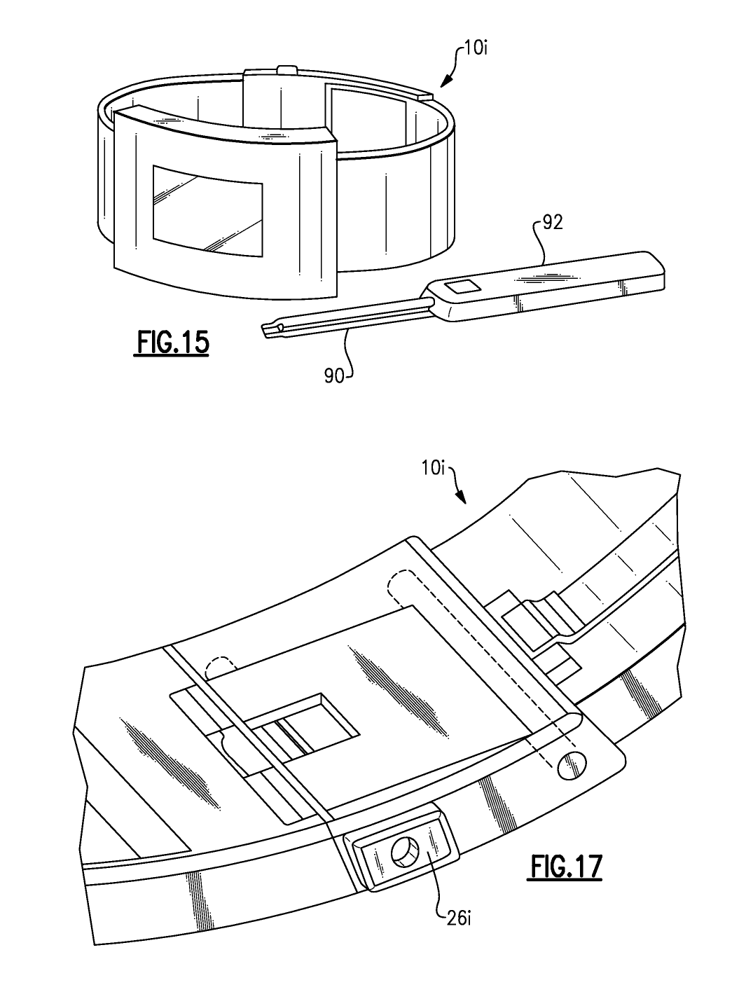

FIG. 14 illustrates a tracking device 10h according to an eighth alternate embodiment. In this embodiment, the lock 78 connects to links 80 of a bracelet, necklace, anklet, etc. The tracking hardware (e.g. the locating circuitry 50 and communication circuit 52 of the preceding Figures) may be incorporated in one of the links 80a and/or may be incorporated in a charm 82a, where it will blend in with other charms 82 connected to the links 80.

In any of the above embodiments, the tracking device could comprise simply a communication circuit 52, which can be tracked by triangulation from cell towers, using known technology. In that manner, referring to FIG. 5, the server 64 would determine the location of the tracking device directly (i.e. without necessity of communicating the location from the tracking device).

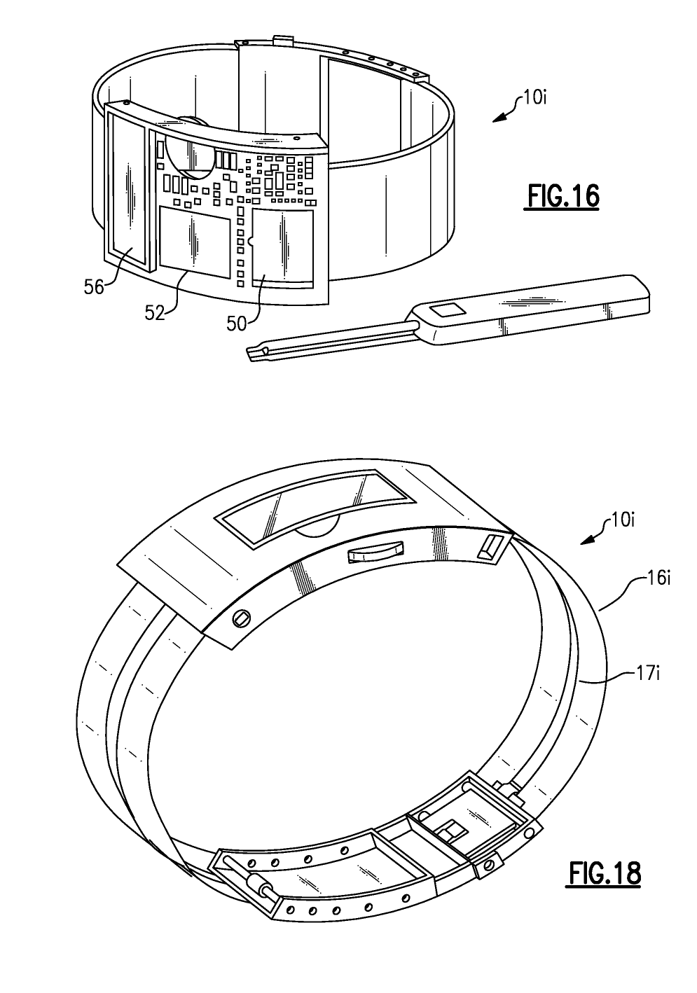

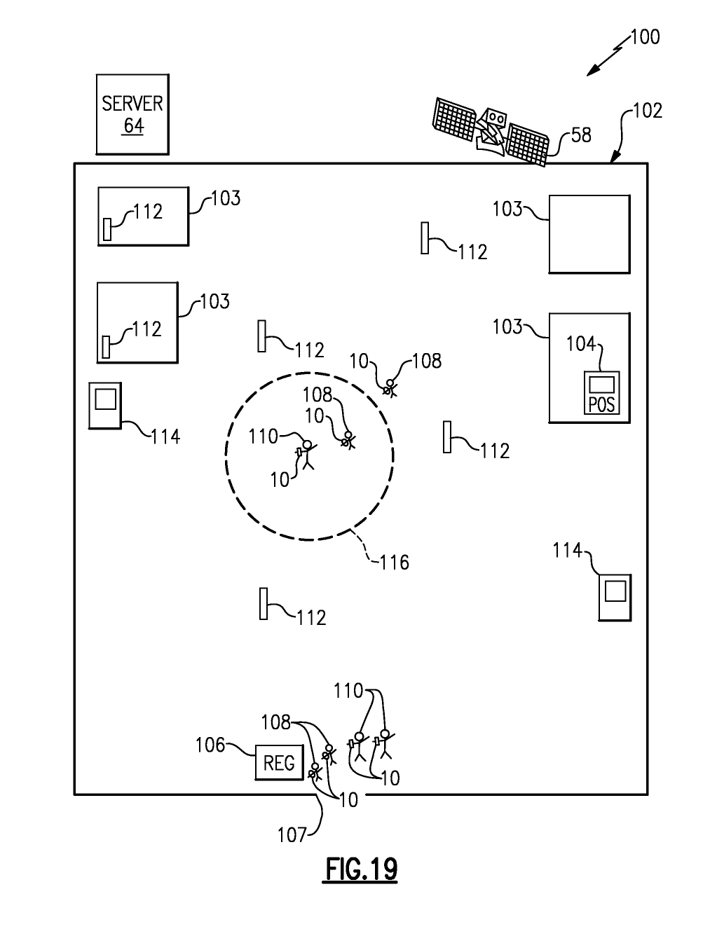

FIGS. 15-18 illustrate a tracking device 10i according to a ninth embodiment, which is similar to the previous embodiments described above. The tracking device 10i includes a band 16i having a cable 17i inside to resist cutting. The tracking device 10i includes locating circuitry 50, communication circuitry 52, and the health monitoring circuit 56. The communication circuitry 52 includes local communication protocols (e.g. Bluetooth, wi-fi, etc) together with (optionally) the longer range (e.g. cell tower, satellite, etc) communication protocols. The tracking device 10i includes a keyway 26i for operating the lock. The key 90 may be provided as retractable into a key body 92, either by pivoting into a recess in the key body 92, or telescoping in and out of the key body 92. Alternatively, the key body 92 could be a metal tube, to reduce the size of the key body 92. The tracking device 10i also includes an activatable alert, such as a light (flashing or activated) and/or a particular sound (e.g. a voice requesting park personnel to be contacted) and/or vibration. The alert can be activated by the tracking servers either automatically and/or by authorized personnel.

Any of the embodiments described above could be used in several additional applications described below.

Referring to FIG. 19, in one example tracking and monitoring system 100, the tracking device 10 could be used to monitor one or more children and/or other person in a large public setting 102, such as an amusement or theme park 102. The park 102 includes one or more controlled entrances/exits 107 to a plurality of attractions 103 (such as rides or stores) that may include POS 104 computers.

One or more parent/adult/guardians 110 would be giving a tracking device 10 secured to them by key. Every child 108 that enters the park 102 through the turnstiles would be given a tracking device 10 secured to them by key. Every child tracking device 10 is scanned and logged, such as by RF or Bluetooth scanners, to register each tracking device 10 to each child. Every child 108 in each family or group (and their associated tracking device 10) is associated with the tracking device 10 logged in a guardian electronic profile through the tracking device 10 and contact information. The tracking devices 10 of the children 108 are associated with the tracking devices 10 of the guardians 110 at a registration computer 106 near the entrance 107. The tracking devices 10 are tracked by gps satellites 58, communication circuitry (e.g. cell tower triangulation) as described above and/or by local RF (e.g. Bluetooth) transceivers 112 located through the park 102. The local transceivers 112 may be necessary inside buildings or inside the attractions 103, where cell tower and/or gps satellite 58 signals do not reach.

In the park 102, the server 64 tracks the locations of all of the tracking devices 10. The server 64 repeatedly monitors the locations of the tracking devices 10 relative to the associations between the tracking devices 10 (e.g. guardian/child), the relative locations of the associated devices 10, the boundaries of the park and other criteria. For example, the server 64 may set a radius 116 around each guardian tracking device 10. If the server 64 detects that one of the associated child tracking devices 10 is outside the radius 116 (or outside both or all of the radii from the guardians 110, if there are two or more guardians 110) or outside the park boundaries, an alert may be sent to the guardian 110 (via the tracking device 10) and to the child 108 (such as by activating the alerts on the tracking device 10, such as flashing light, audible alerts, etc).

Kiosks 114 may be set up at various locations. The kiosks 114 are computers with displays (such as touch screen displays) with readers capable of reading the parent's tracking device 10 for authentication. After authentication, the kiosk 114 will display the current location of all the tracking devices 10 that are associated with the guardian's tracking device 10. The kiosk 114 will also give the guardian the option of activating the “lost child alert” (e.g. flashing light, audible alerts, etc) on any particular associated child tracking device 10. This will attract assistance from park employees to the missing child.

The kiosks 114 may also display the location of associated guardian tracking devices 10. For example, a group that has split into smaller groups may want to reconnect, such as a family where the older children 108 go to one ride 103 with one guardian 110 and the younger children 108 go to another ride 103 with another guardian 110. This is also useful for school groups, church groups, multiple families or other larger groups traveling together, so that they can reconnect sometimes.

Park personnel will have access to the tracking system 100 to locate a guardian 110 or child 108 when requested by a person (guardian 110 or child 108) having an associated tracking device.

### EXAMPLE

Family/Group of (1 to 10 or 20) kid bracelets 10 are associated with one or more adult bracelets 10. When a child 108 is separated or has breached the perimeter fence radius 116 from the family/group (i.e. it is detected that the child is separated from the guardian by a distance exceeding a threshold or the child has left a pre-determined perimeter, such as the boundaries of the park), the parent tracking device 10 is alerted.

When the parent/guardian 110 is separated or has breached a perimeter fence radius (not shown) from the children/group 108 the entire group tracking devices 10 are activated or alerted.

This information below explains how the analysis's tracking & monitoring software on server 64 can be used in a bracelet 10 while being secured to the body by key. In addition, it can operate in conjunction with the bracelets 10 as well. This tracking bracelet 10 is designed for consumers that visit amusement parks, theme parks, and many more public places.

Analytics Software, Product Analysis, Purchase Activity, Monitoring Consumer's Travel

Each consumer that enters the amusement park 102 will have the option to wear a product analysis tracking bracelet 10 that will be secured by key. The tracking devices 10 could provide this function in addition to the child tracking function, or the bracelet could simply include a barcode. The consumer will register their (name, race, age, residents, and est.) on a survey card that is logged in the server 64. The consumer's information will be logged with the analysis tracking bracelet barcode or the child tracking device 10.

As the consumer travels throughout the amusement park 102 the analysis tracking bracelet 10 monitors the purchase activities and consumer's travel. When the consumer makes a purchase, the cashier scans the bracelet 10 first, before scanning the consumer merchandise. The bracelet 10 can be associated with a payment method, such as a room account, credit card, credit account, etc. For older children 108, a prepaid account can be associated with the bracelet 10 and used to make limited purchases. The merchandise purchased is then logged to the consumer's information with barcode using normal POS software. The receipt will display merchandise purchased, and the analysis tracking barcode only. The electronic information is stored, and calculated by park personnel for daily analysis on server 64.

The tracking device 10, via activation by the short-range communication could be used to play audio and/or video presentations, such as pre-recorded information at selected locations, advertisements, discounts, rides, stores, products, etc.

Armed Forces

The Armed Forces officers can track and monitor the soldiers in the field by central server. The soldiers' health, vital signs, and their location are tracked and monitored with a bracelet. The soldier's body can be located after loss of life.

The bracelet will provide identity, passport, health record, dental records, organ donor information, allergies, and contact information as a secondary ID.

This information is only accessed by Armed Forces Officers. This process will be activated by scanning the bracelet or Wi-Fi, Bluetooth, or RF connection technology, and or GPS tracking technology. Same as the computer scan system for theme parks.

Hospital's Emergency Room Procedures

ER Optional Bracelet Design

Throwaway/Disposable Bracelets with temporary key or other types of locking mechanism and health monitoring capabilities. Such as heart rate, temperature, blood pressure and other health vital signs.

Hospitals provide each patient that comes in the ER a bracelet to monitor health vital signs, from a server that is located in the facility or communicate with main server, while the patient is waiting to be seen by the doctor.

A heart monitoring chest strap can be used in the ER while waiting to be seen by the doctor. Doctors can also monitor the patient's health at home. The heart monitoring strap will monitor heart rate and have two body temperature sensors, which are located on the strap below the underarm area. The strap will optionally have a flexible cable in between the material (to prevent removal), and a key lock mechanism. The strap will either transmit information directly to a server or directly to the bracelet, which will relay it to a server. The strap will be tracked and monitored by a server in the hospital or a company 24/7 station/server call center. Doctors and staff members can access the information through website, software application on a smart phone, and or contact 24/7 station/server call center.

The bracelet will beep or light up when the vital signs have reach in normal health vitals. The patient will immediately return to the front desk or be notified by hospital staff member.

Patients can be released from the hospital for home care, and the doctors can have access to their vital signs, medical condition, and medical history through a bracelet. The information is accessed through application software on their smart phone or website server or by contacting company 24/7 monitoring station/server. Doctors and staff members can access the information through website or and software application on a smart phone.

Patients that own a bracelet prescribed to them by their doctor and enter the ER with the bracelet on, will make for easy access to their current vital signs, medical condition, allergies, and medical history records.

This process will be activated by scanning the bracelet or Wi-Fi, Bluetooth, or RF connection technology. Same as the computer scan system for theme parks.

Emergency Accident

At the scene of an emergency where the person is unconscious and has no identification, the bracelet can be used to provide information about the current health vitals, medical history, allergies, and doctors contact information.

The emergency crew can access the server through application software on a smart phone or a computer that will allow immediate access to company website, and or contact company 24/7 monitoring station/server.

The patient personal information can be accessed after the wristband has been scanned by a compatible device or Wi-Fi, Bluetooth; RF connection technology has been activated.

The patient information is protected by security procedures. Only the patient and licensed medical professionals can access the medical information through user name and pass code.

Sports

Sports Bracelet Design

Fashionable rubber band that one size fits all wrists and come in many colors, and is imbedded with a health monitoring chip/sensor inside it. Such as heart rate, temperature, blood pressure and other health vital signs are monitored.

Providing each athlete a light weight rubber band to monitor their vital signs and health while performing and practicing.

The team trainer and coaches can monitor the health of their team players from a local server, smart phone application software, and or contact company station/server.

Traveling

People travel every day internationally and domestically and lose their identification and personal information.

The bracelet will provide identity, passport, health record, dental records, organ donor information, allergies, and contact information as a secondary ID.

The information can be accessed through application software on a smart phone, website, by user name and pass code, and or by company 24/7 monitoring station/server.

Referring to FIG. 21, the tracking device 10 can also be used for pets. Again, GPS can be used for outdoor tracking Short-range communications can be used for indoor tracking Indoor and outdoor perimeter fences can be defined and monitored. Alerts (flashing lights, audible alerts, etc) can also be provided.

Emergency Room Doctor & Triage 2nd Nurse

The ER Triage Second Nurse health station is a private secure closed in booth or room. Each patient will have the option to pick a pre-package labeled health container kit that meet their request and needs. The instruments inside the kit are used for the health station to perform their specific medical procedures.

The doctor or medical staff can watch through a video camera as the patients register all their health vitals and medical condition information. The doctor or medical staff can communicate with the patient inside the health station by speaker or telephone for more serious concerns and provide more instructions or request.

The health station will have the capability to log and register the patients by scanning their identification card (I.D.), insurance card, and or by their health bracelet. This will immediately pull up all their health records and register all their current health vitals that are being taking inside the booth. The patient can enter their email for electronic receipt.

The health station will track, monitor, and detect for the following blood pressure, body temperature, vitals sign, HIV blood test, blood oxygen, blood testing, drug screening, pregnancy test, height, weight, and alcohol breathalyzer.

The computer touch screen will provide a list of questions with an automated voice that will ask a sequence of health questions. For example: What is your reason for visiting the Emergency Room today?

The health station will have its own secure biohazard container to receive blood, and dispose all used medical supplies, to prevent blood borne pathogens.

The health station computer will register all patients into the ER log sheet to be seen by the doctor.

The medical staff can monitor multiple health stations through a video monitor to move the triage procedures more conveniently. The medical staff can also retrieve the health information from a computer or software application on a smart phone to help speed their diagnoses.

Although an example embodiment has been disclosed, a worker of ordinary skill in this art would recognize that certain modifications would come within the scope of the claims. For that reason, the following claims should be studied to determine their true scope and content.

What is claimed is:

1. A method for monitoring a child in a park including the steps of:
a) assigning a child tracking device to the child;
b) assigning a guardian tracking device to a guardian of the child;
c) associating the child tracking device with the guardian tracking device; and
d) monitoring a location of the child tracking device in the park.

2. The method of claim 1 further including the step of monitoring a location of the guardian tracking device.

3. The method of claim 2 further including the step of monitoring relative locations of the guardian tracking device and the child tracking device.

4. The method of claim 2 further including the step of monitoring a distance between the guardian tracking device and the child tracking device and generating an alert based upon the distance.

5. The method of claim 4 further including the step of monitoring the location of the child tracking device relative to a park boundary and generating an alert based upon the relative locations of the child tracking device and the park boundary.

6. The method of claim 4 wherein the step of generating an alert includes the step of activating a visual alert on the child tracking device.

7. The method of claim 3 wherein said step d) is performed using gps outdoors and using local wireless communication connections indoors.

8. The method of claim 1 further including the step of displaying the child tracking device on a kiosk after authenticating the guardian tracking device.

9. The method of claim 1 further including the step of monitoring purchases associated with the guardian tracking device.

10. The method of claim 9 further including the step of associating a payment method for the purchases with the guardian tracking device.
